(19) United States
(12) Patent Application Publication
(10) Pub. No.: US 2025/0032824 A1
(43) Pub. Date: Jan. 30, 2025

(54) APPARATUS FOR ASCENDING AND DESCENDING A LINE WITH A LOAD

(71) Applicant: Reg COATES, Victoria (CA)

(72) Inventor: Reg COATES, Victoria (CA)

(21) Appl. No.: 18/358,716

(22) Filed: Jul. 25, 2023

(51) Int. Cl. A62B 1/14

(52) U.S. Cl. CPC A62B 1/14

(57) ABSTRACT

An apparatus for ascending and descending a line with a load, which includes: a base plate having a first end and a second end opposite to the first end; a first guide connected to the base plate at the first end; a rocker arm member pivotally connected to the base plate between the first end and the second end; and a release member pivotally connected to the base plate between the first end and the second end, the release member being opposite the rocker arm member; wherein the line passes through the apparatus between the rocker arm member and the first guide and between the rocker arm member and the release member when the apparatus is in an unloaded configuration and the line is compressed in the apparatus between the rocker arm member and the first guide when the apparatus is in a loaded configuration.

### TECHNICAL FIELD

This invention relates to apparatuses for suspending a load on a line or rope and more particularly to an apparatus for ascending and descending a line or rope with a load, which is capable of controlling the descent of an attached load and constituting a self-locking safety device.

### BACKGROUND

In the current state of the art, there are various apparatuses that act as safety devices for an individual ascending or descending a vertically hung rope.

Examples of some prior art apparatuses for ascending or descending a rope are described in U.S. Pat. No. 6,902,031 to Ador, U.S. Pat. No. 8,387,751 to Miceli, U.S. Pat. No. 10,245,452 to Ollivier, French Patent Registration No. 8800768 to Petzl, and E.P. No. 1329242 to Maurice.

The prior art apparatuses disclose of various mechanisms for controlling the descent of an attached load along a vertically hung rope. Most of these mechanisms deploy a number of levers, springs, cleats and other structural components that complicate the functioning of the device, which leads to device malfunction or ineffective functioning (e.g., inability to completely and fully stop the uncontrolled descent of a user down the vertically hung rope). Such devices are prone to jamming or malfunction by the introduction of dirt, water, and other environmental debris.

Accordingly, there is a need for a simpler device that is less prone to malfunctioning and effective at controlling the descent of a load down a vertically hung rope.

An object of the invention is to address the above shortcomings.

### SUMMARY

The above shortcomings may be addressed by providing, in accordance with one aspect of the invention, an apparatus for ascending and descending a line with a load. The apparatus includes: a base plate having a first end and a second end opposite to the first end; a cover plate connected to the base plate and in parallel alignment with the base plate; a first guide connected to the base plate at the first end and disposed between the base plate and the cover plate; a rocker arm member pivotally connected to the base plate between the first end and the second end and disposed between the base plate and the cover plate; and a release member pivotally connected to the base plate between the first end and the second end, the release member being opposite the rocker arm member and disposed between the base plate and the cover plate; wherein the line passes through the apparatus between the base plate and the cover plate, between the rocker arm member and the first guide and between the rocker arm member and the release member when the apparatus is in an unloaded configuration and the line is compressed between the rocker arm member and the first guide when a force is applied by a weight of the load to pivot the rocker arm member towards the first guide and the apparatus is in a loaded configuration.

The rocker arm member may include a load bearing portion. The load bearing portion may define a load aperture for attaching the load.

The release member may include an abutment member having a pivoting end and a free end; and an elongated member opposite and connected to the abutment member at the free end, the elongated member operable to pivot the abutment member towards the line when a force is applied to the elongated member, causing the line to be released from being compressed between the rocker arm member and the first guide, and shifting the apparatus from the loaded configuration to the unloaded configuration.

The load aperture may have an elongated shape.

The load bearing portion may include a lower edge at a periphery of the load bearing portion, the load aperture may include a resting edge on which the load weighs down on, and the resting edge may be inclined at an angle of degrees relative to the lower edge.

The load aperture may include a curved resting edge.

The rocker arm member may further include a line abutment portion opposite the load bearing portion. The line abutment portion may include a tapered portion for providing additional grip on the line. The line abutment portion and the load bearing portion may define a rocker shape.

In the loaded configuration, the load may be attached to the load bearing portion and the load may exert a force on the rocker arm member to cause the rocker arm member to pivot and the line abutment portion to compress the line against the first guide.

The pivoting end may define a cam heel adjacent a pivot axis, and the free end may define a cam lobe remote from the pivot axis, the cam lobe having an abutment surface.

The abutment surface may be curved.

The abutment member may ovular in shape.

The elongated member may be an elongated handle.

The apparatus may further include a second guide connected to the base plate at the second end and disposed between the base plate and the cover plate.

The first guide and the second guide may include a rounded channel for accommodating a shape of the line.

The cover plate may be removably connected to the base plate.

The apparatus may further include a chest tether connector at the first end. The chest tether connector may be a hand operable fastener extending through the base plate and the cover plate.

The apparatus as described, in particular, the features of the rocker arm member and the release member, and the mechanism provided for locking or holding a line or rope in the apparatus provide for a simpler device that is less prone to malfunctioning and effective at controlling or stopping the descent of a load down a vertically hung line or rope.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective front view of an apparatus for ascending and descending a line with a load according to an embodiment of the invention;

FIG. 2 is a perspective front view of the apparatus shown in FIG. 1, with the cover plate removed;

FIG. 3 is a perspective front view of the apparatus shown in FIG. 2, in an unloaded configuration, in use with a line and a carabiner;

FIG. 4 is a perspective front view of the apparatus shown in FIG. 2, in a loaded configuration, in use with a line and a carabiner;

FIG. 5 is a perspective right side view of the apparatus shown in FIG. 1;

FIG. 6 is a perspective left side view of the apparatus shown in FIG. 1; is a perspective front view of an apparatus for ascending and FIG. 7 descending a line with a load according to a second embodiment of the invention, with the cover plate removed, and in use with a line and a carabiner;

FIG. 8 is an exploded view of the apparatus shown in FIG. 7, with the cover plate included; and

FIG. 9 is a perspective front view of an apparatus for ascending and descending a line with a load according to a third embodiment of the invention.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made. It will be readily understood that the aspects of the present disclosure, as generally described herein, and illustrated in the figures, can be arranged, substituted, combined, separated, and designed in a wide variety of different configurations, all of which are explicitly contemplated herein.

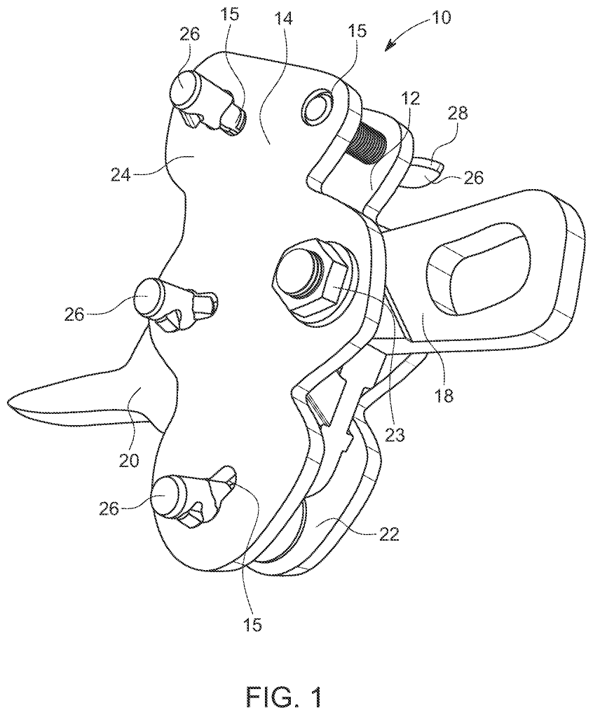

Referring to FIGS. 1 to 9, an apparatus for ascending and descending a line 100 with a load according to an embodiment of the invention is shown generally at 10. Apparatus 10 includes: a base plate 12; a cover plate 14; a first guide 16; a rocker arm member 18; and a release member 20.

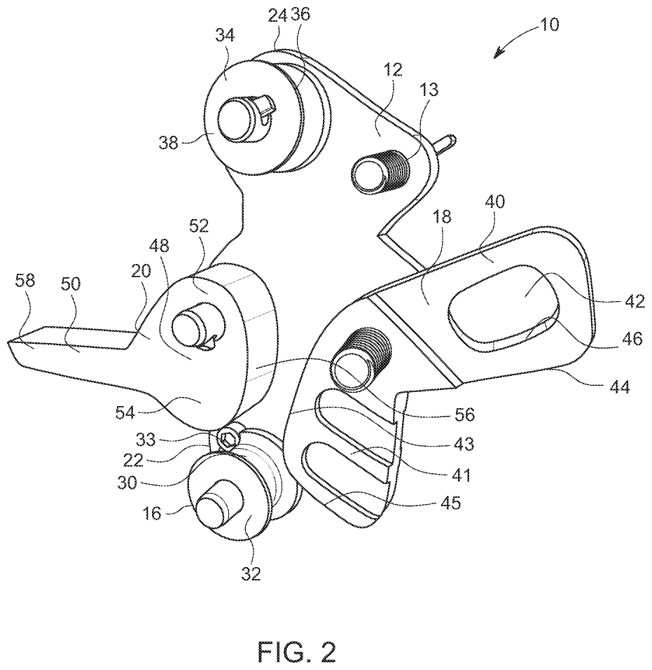

Referring to FIG. 2, base plate 12 has a first end 22 and a second end 24. Second end 24 is opposite to first end 22. Base plate 12 includes a number of base plate apertures 13. Base plate apertures 13 are used for the insertion of fasteners to fasten various components, such as cover plate 14, first guide 16, rocker arm member 18, and release member 20, to base plate 12. While base plate 12 is illustrated to include base plate apertures 13, it will be understood by a person skilled in the art that base plate 12 may not include any base plate apertures 13 or a different number of base plate apertures 13. It will be understood by a person skilled in the art that cover plate 14, first guide 16, rocker arm member 18, and release member 20 may all be secured to base plate 12 in any other suitable manner known to the art (for example, by welding said components directly to base plate 12, or by using different fasteners and fastening mechanisms). Base plate 12 may of any suitable shape, size and material. As shown, base plate 12 is shaped to accommodate all components that need to be mounted on to base plate 12 with excess material trimmed to reduce weight and bulk. However, it will be understood by a person skilled in the art that base plate 12 may be of any other suitable shape, such as rectangle, oval, etc. As shown, base plate 12 is approximately 12.5 cm long (at the longest part of base plate 12) and 6.5 cm wide (at the widest part of base plate 12). However, it will be understood by a person skilled in the art that base plate 12 may be of any other suitable dimensions.

Referring to FIGS. 1, 5 and 6, cover plate 14 is connected to base plate 12 in a parallel alignment with base plate 12. Cover plate 14 is of the same shape, size and material as base plate 12. However, it will be understood by a person skilled in the art that cover plate 14 may be of any other suitable shape, size and material. Cover plate 14 includes a number of cover plate apertures 15. Cover plate apertures 15 are used for the insertion of fasteners to fasten various components to cover plate 14 or cover plate 14 to various components, such as to base plate 12. While cover plate 14 is illustrated to include cover plate apertures 15, it will be understood by a person skilled in the art that cover plate 14 may not include any cover plate apertures 15 or a different number of cover plate apertures 15. As shown, cover plate 14 is removably and rotatably connected to base plate 12 with a nut and bolt assembly 23 that extends through base plate 12, rocker arm member 18 and cover plate 14. While nut and bolt assembly 23 serves as the primary mechanism to secure cover plate 14 to base plate 12, three SLIC Pins™ 26 (self-locking implanted cotter pins) are used to provide both additional means to secure cover plate 14 to base plate 12 and means for easy partial detachment of cover plate 14 for the purposes of inserting line 100. A SLIC Pin™ 26 is a pin with at least one built-in, retractable, spring-loaded cotter that provides a quick locking function. However, it will be understood by a person skilled in the art that cover plate 14 may be connected to base plate 12 in any manner. For example, cover plate 14 may be permanently affixed (by any means commonly used in manufacturing processes) or hingedly connected to base plate 12 (by any means commonly used in manufacturing processes).

Referring to FIG. 2, first guide 16 is connected to base plate 12 at first end 22. First guide 16 is disposed between base plate 12 and cover plate 14. As shown, first guide 16 includes a rounded channel for accommodating a shape of the line such as a first tube 30 and a first flange 32. First flange 32 projects from both ends of first tube 30. First tube 30 includes a concave wall that assists with guiding line 100. In addition to guiding line 100, the concave wall of first tube 30 also provides an interference fit that functions to grip line 100 when line 100 is pressed against first guide 16. First guide 16 is secured between base plate 12 and cover plate 14 when a SLIC Pin™ 26 is inserted through base plate 12, cover plate 14 and the center of first tube 30. SLIC Pin™ 26 includes two built-in, retractable, spring-loaded cotters (wedge-shaped projections). The two built-in, retractable, spring-loaded cotters are spaced apart along the length of SLIC Pin™ 26 and positioned perpendicular to one another along the circumference of SLIC Pin™ 26 to securely and removably hold both first guide 16 and cover plate 14 to base plate 12. First flange 32 includes a cut out 31 that accommodates a corresponding protrusion 33 on base plate 12. Cut out 31 and protrusion 33 prevents first tube 30 from rotating as line 100 passes by first guide 16 and through apparatus 10.

Referring to FIGS. 2, 6 and 8, as shown, apparatus 10 includes a second guide 34. Second guide 34 is connected to base plate 12 at second end 24. Second guide 34 is disposed between base plate 12 and cover plate 14. As illustrated, second guide 34 includes a rounded channel for accommodating a shape of the line, such as a second tube 36 and a second flange 38. Second tube 36 includes a concave wall that assists with guiding line 100. In addition to guiding line 100, the concave wall of second tube 36 also provides an interference fit that functions to grip line 100 when line 100 is pressed against second guide 34. Second guide 34 is secured between base plate 12 and cover plate 14 when a SLIC Pin™ 26 is inserted through base plate 12, cover plate 14 and the center of second tube 36. SLIC Pin™ 26 securely and removably holds both second guide 34 and cover plate 14 to base plate 12. Second flange 38 includes a cut out 37 that accommodates a corresponding protrusion 39 on base plate 12. Cut out 37 and protrusion 39 prevents second tube 36 from rotating as line 100 passes by second guide 34 and through apparatus 10.

However, it will be understood by a person skilled in the art that first guide 16 and second guide 34 may be connected to base plate 12 in any manner. For example, first guide 16 and second guide 34 may be permanently affixed (through welding or by any other means commonly used in manufacturing processes) to base plate 12. Additionally, first guide 16 and second guide 34 are both guiding structures used to guide and position line 100 through apparatus 10. Accordingly, it will be understood by a person skilled in the art that first guide 16 and second guide 34 could be of any other size, shape or structure that may be used to guide or lead line 100 in a desired direction and is not limited to a tube with a flange installment. For example, it may be a solid bollard or stud welded on to base plate 12, or other suitable arrangement. First guide 16 and second guide 34 may have a curved wall or non-curved wall. It will be further understood that while apparatus 10 is shown to include both first guide 16 and second guide 34, apparatus 10 may not include second guide 34. Second guide 34 assists with positioning line 100 in apparatus 10 such that line 100 may be fully stopped from slipping through apparatus 10. Without second guide 34, line 100 may not be fully prevented from slipping through apparatus 10 and instead may only be slowed in the rate at which it slips through apparatus 10.

Referring to FIGS. 2, 5 and 8, rocker arm member 18 is pivotally connected to base plate 12 between first end 22 and second end 24. Rocker arm member 18 is disposed between base plate 12 and cover plate 14. Rocker arm member 18 includes a load bearing portion 40 and a line abutment portion 41. Line abutment portion 41 is opposite to load bearing portion 40. Load bearing portion 40 and line abutment portion 41 define a rocker shape, V-shape, right-angled shape or any other suitably curved or bent shape. Rocker arm member 18 includes a coil spring 47. Coil spring 47 is disposed between rocker arm member 18 and base plate 12. Coil spring 47 biases line abutment portion 41 towards release member 20.

Line abutment portion 41 has a first edge 43 and a second edge 45. First edge 43 and second edge 45 are at an angle of approximately 110° to each other. First edge 43 is approximately 4 cm in length. Second edge 45 is approximately 3 cm in length. The dimensions and shape of line abutment portion 41 assists with effectively compressing and holding line 100 between line abutment portion 41 and first guide 16. However, it will be understood by a person skilled in the art that line abutment portion 41 may be of any suitable size and shape.

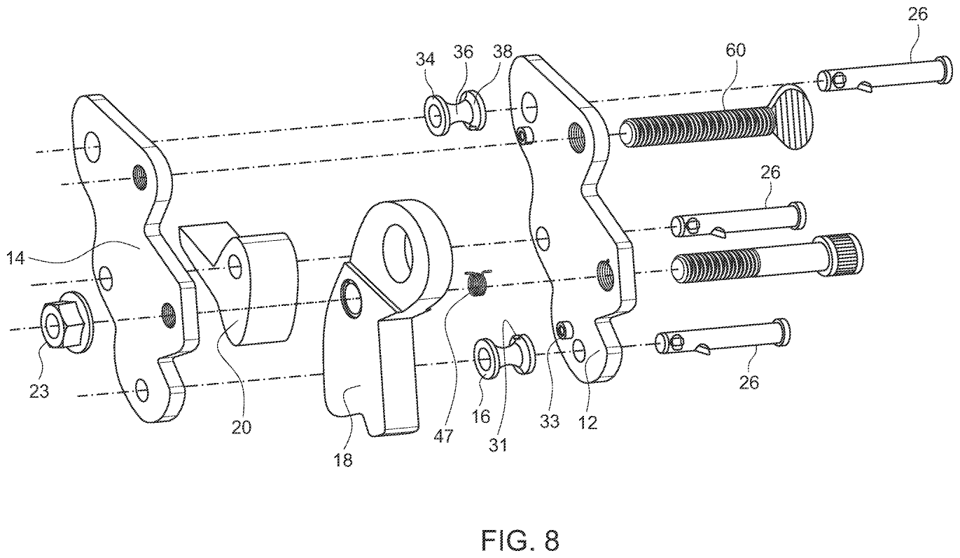

As shown in FIGS. 7 and 8, in a different embodiment of the invention, line abutment portion 41 includes a tapered portion, such as hook-shaped protrusion 62. Hook-shaped protrusion 62 protrudes from second edge 45 at an angle of approximately 130°. Hook-shaped protrusion 62 functions to provide extra grip on line 100 when line abutment portion 41 is pressed against line 100 and first guide 16. It will be understood by a person skilled in the art that hook-like shaped protrusion 62 may have any other suitable tapered or pointed shape to provide extra grip on line 100.

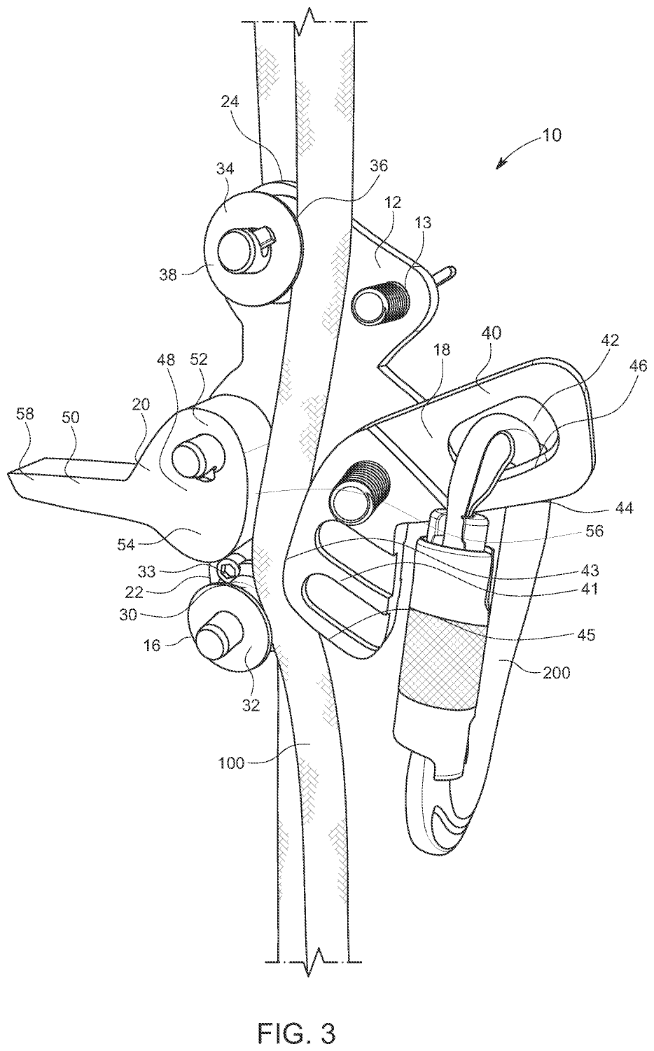

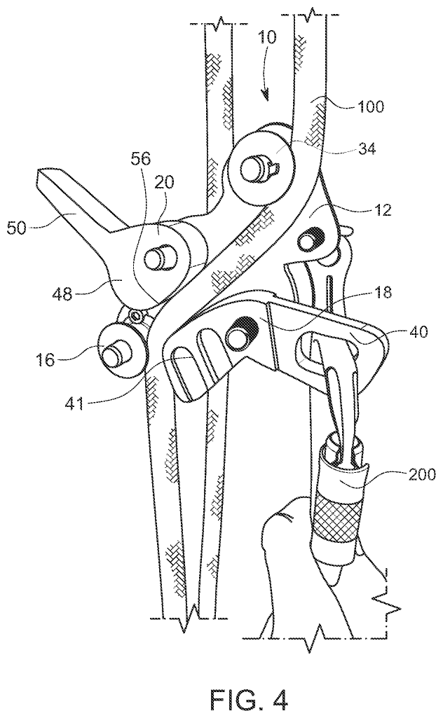

Referring to FIG. 2, load bearing portion 40 defines a load aperture 42 for attaching the load. Load bearing portion 40 has a lower edge 44 at a periphery of load bearing portion 40. The load may be a person or any weighted object. The load may be attached by any reasonable means. As illustrated in FIGS. 3 and 4, the load is attached by a carabiner 200. As illustrated, load aperture 42 has an elongated shape and has a length of approximately 2.2 cm and width of approximately 1.5 cm. Load aperture 42 has a resting edge 46. Resting edge 46 is curved. As shown, resting edge 46 is inclined at an angle of approximately 10° relative to lower edge 44. The shape and positioning of load aperture 42 in relation to load bearing portion 40, and in particular, to lower edge 44 of load bearing portion 40, allows for increased leverage in pivoting line abutment portion 41 towards first guide 16. The angle of incline of resting edge 46 to lower edge 44, the curvature of resting edge 46 and the elongated shaped of load aperture 42 all assist in the shifting of the attached load (and correspondingly, the force applied) to pivot rocker arm member 18 back and forth. However, it will be understood by a person skilled in the art, that such features as described may be varied. For example, the angle of incline of resting edge 46 to lower edge 44 may be changed (to a different angle or to no angle), the curvature of resting edge 46 may be adjusted (to being more or less curved or flat), the elongated shape of load aperture 42 may be adjusted (to being more elongated, less elongated or not elongated at all) and the size, shape and dimensions of load aperture 42 may be varied. As shown in FIGS. 7 and 8, in a different embodiment of the invention, load aperture 42 is circular in shape. As shown in FIG. 7, load aperture 42 has an approximate diameter of 16 mm.

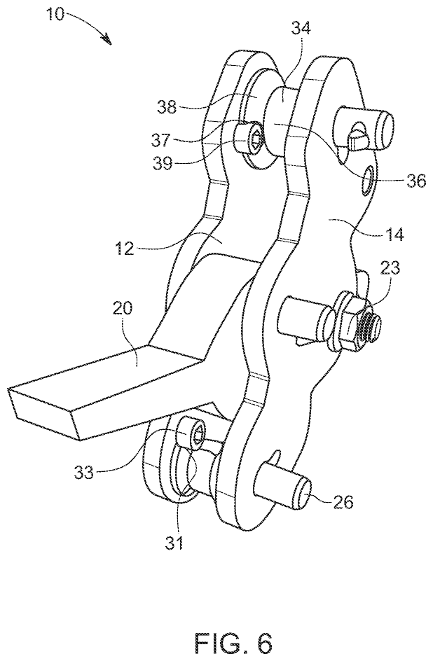

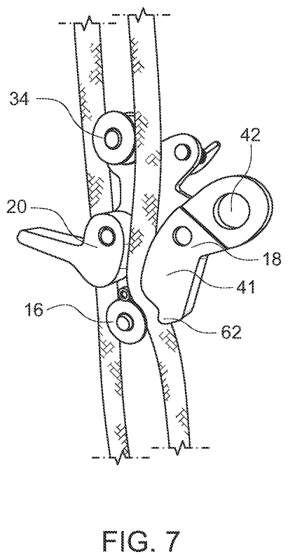

Referring to FIGS. 2 and 6, release member 20 is pivotally connected to base plate 12 between first end 22 and second end 24. Release member 20 is opposite rocker arm member 18 and disposed between base plate 12 and cover plate 14. Release member 20 includes an abutment member 48 and an elongated member 50. Abutment member 48 includes a pivoting end 52 and a free end 54. Pivoting end 52 is pivotally connected to base plate 12. Pivoting end 52 defines a cam heel adjacent a pivot axis. Free end 54 defines a cam lobe remote from the pivot axis. Free end 54 includes an abutment surface 56. As illustrated, abutment member 48 is ovular in shape and abutment surface 56 is curved. The ovular shape of abutment member 48 and the resulting curvature of abutment surface 56 assists in the smooth sliding of line 100 between release member 20 and rocker arm member 18 when abutment surface 56 is pressed against line 100. However, it will be understood by a person skilled in the art that abutment member 48 may be of any other suitable shape or form and abutment surface 56 may correspondingly vary in curvature (from being more curved, less curved, or not curved at all).

Elongated member 50 is opposite and connected to abutment member 48 at free end 54. As shown, elongated member is an elongated handle 58. Elongated member 50 acts as a handle for a user to apply force upon to pivot attached abutment member 48 towards rocker arm member 18 and line 100. While attachment of elongated member 50 to abutment member 48 at free end 54 is beneficial in providing extra leverage and increasing the force applied to a line by abutment surface 56, it will be understood by a person skilled in the art that elongated member 50 may be attached to abutment member at pivoting end 52 or any other suitable location. It will be further understood that elongated member 50 may be of any suitable size and shape and may not necessarily be elongated in shape.

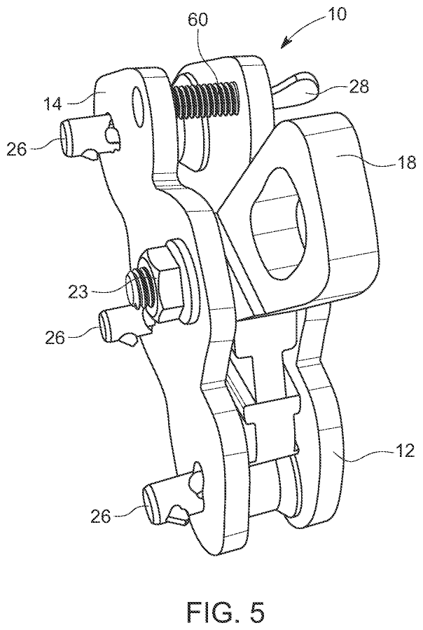

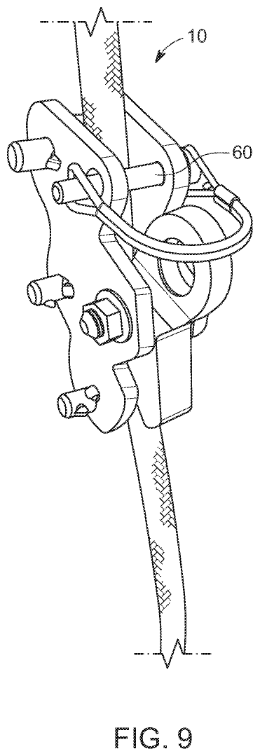

Referring to FIGS. 2 and 5, apparatus 10 includes a chest tether connector 60 at first end 16. As shown in FIG. 5, chest tether connector 60 is a hand operable fastener 28 extending through base plate 12 and cover plate 14. As shown, hand operable fastener 28 is a spade head thumb screw. However, it will be understood by a person skilled in the art that hand operable fastener 28 may be any other fastener operable by hand, such as a wing screw. Hand operable fastener 60 forms an easily removable rod that extends between base plate 12 and cover plate 14 for attachment of a chest tether (not shown). Thus, as shown in FIG. 9, it will be understood by a person skilled in the art that chest tether connector 60 may also be a clip or any other mechanism for attaching a chest tether.

### Operation

Referring to FIGS. 2, 3 and 4, in use, a rope or line 100 is fed through apparatus 10 between first guide 16 and second guide 34, between base plate 12 and cover plate 14, between rocker arm member 18 and release member 20, and between first guide 16 and rocker arm member 18. A load, such as a person, is attached to a carabiner 200 and carabiner 200 is attached to load bearing portion 40 via load aperture 42. FIG. 3 shows apparatus 10 in an unloaded configuration, and FIG. 4 shows apparatus 10 in a loaded configuration.

The end of line 100 may be inserted into apparatus 10 from first guide 16 to second guide 34 or from second guide 34 to first guide 16. Alternatively, if it is inconvenient or impractical to feed an end of line 100 into apparatus 10, line 100 may be inserted into apparatus 10 in the middle of line 100. To insert line 100 into apparatus 10 in the middle of line 100, the user would disengage the cotters on SLIC Pins™ 26, pull SLIC Pins™ 26 to at least beyond cover plate 14, and swivel cover plate 14 out of the way to enable the user to insert line 100 between first guide 16 and second guide 34, between base plate 12 and cover plate 14, between rocker arm member 18 and release member 20, and between first guide 16 and rocker arm member 18.

Line 100 is either locked in apparatus 10 in the loaded configuration, passing through apparatus 10 in a controlled manner in between the loaded and unloaded configurations, or freely passing through apparatus 10 in the unloaded configuration.

Referring to FIG. 3, in an unloaded configuration, apparatus 10 is in a position that is relatively close to being in parallel alignment with a vertically hung rope or line 100. In the unloaded configuration, line 100 freely passes through apparatus 10 between base plate 12 and cover plate 14, between rocker arm member 18 and first guide 16, and between rocker arm member 18 and release member 20. Line 100 passes through apparatus 10 when no force is exerted upon load bearing portion 40 of rocker arm member 18 to pivot line abutment portion 41 towards line 100 and release member 20. Such is the case when a user's weight is not depending from carabiner 200 and load bearing portion 40 of rocker arm member 18. However, even in this unloaded configuration, coil spring 47 exerts a small force on rocker arm member 18 to bias line abutment portion 41 towards line 100 and first guide 16 and release member 20, thus preventing line 100 from free slipping through apparatus 10 and instead, gently holds apparatus 10 in place on line 100.

In between the loaded and unloaded configurations, line 100 slides through apparatus 10 in a controlled manner when there is a force being exerted on load bearing portion 40 (for example, the weight of the user hanging off of the attached carabiner 200) and on release member 20 (for example, when a user applies force on elongated member 50). When a force is exerted on load bearing portion 40, line abutment portion 41 pivots towards line 100 and release member 20. When a force is exerted on elongated member 50, free end 54 and in particular, abutment surface 56, pivots towards line 100. These two opposing forces counteract each other, releasing line 100 from being compressed between rocker arm member 18 and first guide 16 and instead, compressing line 100 between release member 20 and rocker arm member 18.

Referring to FIG. 4, in a loaded configuration, apparatus 10 is in a position that approaches being perpendicular to a vertically hung line 100 or that is tilted at an angle relative to a vertically hung line 100. In this loaded configuration, line 100 is locked in apparatus 10 or fully prevented from slipping through apparatus 10. In the loaded configuration, a load (such as the weight of the user) is attached to load bearing portion 40 via carabiner 200, and the load is exerting a force on rocker arm member 18 to cause line abutment portion 41 to pivot towards line 100 and compress line 100 against first guide 16. Accordingly, in the loaded position, line 100 is compressed between rocker arm member 18 and first guide 16 and line 100 is completely prevented from slipping through apparatus 10.

Referring to FIGS. 3 and 4, when a user desires to transition between the loaded and unloaded configuration and allow line 100 to slide through apparatus 10 in a controlled manner, the user would apply force on elongated member 50 to pivot free end 54 and abutment surface 56 towards line 100 and rocker arm member 18. Doing so would shift line 100 away from being compressed between line abutment portion 41 of rocker arm member 18 and first guide 16 to being compressed between abutment surface 56 and line abutment portion 41 of rocker arm member 18. As abutment surface 56 of release member 20 is pressed against line 100 and towards line abutment portion 41 of rocker arm member 18, rocker arm member 18 pivots back towards the position it was in in the unloaded configuration. As long as the force being exerted on load bearing portion 40 of rocker arm member 18 is being balanced by the force being exerted on elongated member 50 of release member 20, line 100 will remain compressed between rocker arm member 18 and release member 20 and line 100 will slide between rocker arm member 18 and release member 20 in a controlled manner. The shape of abutment member 48 and the resulting curvature of abutment surface 56 assists in allowing line 100 to slide between rocker arm member 18 and release member 20 in a controlled manner. Further, as shown, the shape and positioning of load aperture 42 allows an attached carabiner 200 to shift along resting edge 46 depending on the position of rocker arm member 18 and the forces being exerted on rocker arm member 18. As shown in FIGS. 3 and 4, when a force is applied to carabiner 200 (such as the weight of a user depending from carabiner 200), carabiner 200 will shift towards the end furthest from line abutment portion 41 in elongated load aperture 42. When a force is applied to pivot rocker arm member 18 in the opposite direction (such as the application of force by a user on elongated member 50 to pivot abutment member 48 towards line abutment portion 41), carabiner 200 will shift toward the end closest to line abutment portion 41 in elongated load aperture 42. Accordingly, when a user applies force to pivot release member 20 towards rocker arm member 18 and rocker arm member 18 pivots, carabiner 200 will shift its position along resting edge 46, thereby shifting the direction of the force being exerted on load bearing portion 40 by the load (being the weight of the user). Shifting the direction of the force being exerted on load bearing portion 40 will assist in the pivoting of rocker arm member 18 away from line 100 and first guide 16, thereby permitting line 100 to slip between rocker arm member 18 and release member 20 in a controlled manner.

Accordingly, release member 20 is operable to shift apparatus 10 from the loaded position to the unloaded position by an application of force on elongated member 50. Upon application of force on elongated member 50, abutment member 48 pivots towards rocker arm member 18 to cause line 100 to be released from being compressed between rocker arm member 18 and first guide 16.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. An apparatus for ascending and descending a line with a load, the apparatus comprising:
a base plate having a first end and a second end opposite to the first end;
a cover plate connected to the base plate and in parallel alignment with the base plate;
a first guide connected to the base plate at the first end and disposed between the base plate and the cover plate;
a rocker arm member pivotally connected to the base plate between the first end and the second end and disposed between the base plate and the cover plate; and
a release member pivotally connected to the base plate between the first end and the second end, the release member being opposite the rocker arm member and disposed between the base plate and the cover plate;
wherein the line passes through the apparatus between the base plate and the cover plate, between the rocker arm member and the first guide and between the rocker arm member and the release member when the apparatus is in an unloaded configuration and the line is compressed between the rocker arm member and the first guide when a force is applied by a weight of the load to pivot the rocker arm member towards the first guide and the apparatus is in a loaded configuration.

2. The apparatus of claim 1, wherein the rocker arm member comprises a load bearing portion, the load bearing portion defining a load aperture for attaching the load.

3. The apparatus of claim 2, wherein the release member comprises:
an abutment member having a pivoting end and a free end; and
an elongated member opposite and connected to the abutment member at the free end, the elongated member operable to pivot the abutment member towards the line when a force is applied to the elongated member, causing the line to be released from being compressed between the rocker arm member and the first guide, and shifting the apparatus from the loaded configuration to the unloaded configuration.

4. The apparatus of claim 3, wherein the load aperture has an elongated shape.

5. The apparatus of claim 4, wherein the load bearing portion has a lower edge at a periphery of the load bearing portion, the load aperture has a resting edge on which the load weighs down on, and the resting edge is inclined at an angle of 10 degrees relative to the lower edge.

6. The apparatus of claim 5, wherein the load aperture has a curved resting edge.

7. The apparatus of claim 3, wherein the rocker arm member further comprises a line abutment portion opposite the load bearing portion.

8. The apparatus of claim 7, wherein the line abutment portion comprises a tapered portion for providing additional grip on the line.

9. The apparatus of claim 8, wherein the line abutment portion and the load bearing portion defines a rocker shape.

10. The apparatus of claim 9, wherein in the loaded configuration, the load is attached to the load bearing portion and the load exerts a force on the rocker arm member to cause the rocker arm member to pivot and the line abutment portion to compress the line against the first guide.

11. The apparatus of claim 10, wherein the pivoting end defines a cam heel adjacent a pivot axis, and the free end defines a cam lobe remote from the pivot axis, the cam lobe having an abutment surface.

12. The apparatus of claim 11, wherein the abutment surface is curved.

13. The apparatus of claim 12, wherein the abutment member is ovular in shape.

14. The apparatus of claim 13, wherein the elongated member is an elongated handle.

15. The apparatus of claim 14, further comprising a second guide connected to the base plate at the second end and disposed between the base plate and the cover plate.

16. The apparatus of claim 15, wherein each of the first guide and the second guide comprise of a rounded channel for accommodating a shape of the line.

17. The apparatus of claim 16, wherein the cover plate is removably connected to the base plate.

18. The apparatus of claim 17, further comprising a chest tether connector at the first end.
